(19) United States
(12) Patent Application Publication
(10) Pub. No.: US 2015/0074967 A1
(43) Pub. Date: Mar. 19, 2015

(54) Top loading multi-fiber ferrule and fiber insertion method for array fiber interconnection

(71) Applicant: Alliance Fiber Optic Products, Inc., Sunnyvale, CA (US)

(72) Inventors: Yao Li, Newark, CA (US); Yonglu Ma, Dongguan City (CN); Gang Xu, Dongguan City (CN)

(21) Appl. No.: 14/476,034

(22) Filed: Sep. 3, 2014

Related U.S. Application Data
(60) Provisional application No. 61/960,400, filed on Sep. 18, 2013.

(51) Int. Cl. G02B 6/38

(52) U.S. Cl. CPC G02B 6/3861; G02B 2006/12166
USPC 29/401.1

(57) ABSTRACT

An open-lid fiber connector is described. The open-lid fiber connector allows a human operator or a machine automation to closely monitor how an array of fibers is placed on a step of a staircase and each of the fibers is inserted via a groove into a corresponding hole or hollow channel.

### CROSS-REFERENCE TO RELATED APPLICATION

This application claims the benefits of U.S. Provisional Application No. 61/960,400, filed Oct. 16. 2013, and entitled “Top Loading Multi-fiber Ferrule and Fiber Insertion Methods for Array Fiber Interconnect”, which is hereby incorporated by reference for all purposes.

### BACKGROUND OF THE INVENTION

1. Field of the Invention

The invention is generally related to the area of connectors. In particular, the invention is related to top loading multi-fiber ferrule and fiber insertion method for array fiber interconnection.

2. The Background of Related Art

Broadband internet has experienced a compounded annual bandwidth growth rate exceeding 30% over the last decade. The momentum shows no sign of slowing down as wireless broadband, due to the smart phones and portable devices, joins the game. Recent years have witnessed the building of internet data centers, cloud centers by various internet service providers, video and e-commerce players so that vast amount of data could be replicated and placed near end customers to satisfy their demands for access and download speeds. Interconnect links among servers, data storage, routers and other devices inside a data center take advantages of optical fibers to handle various data applications such as web query, search, and data transmission functions.

One particular class of fiber based interconnect links uses a fiber ribbon with multiple fibers in a linear stitched fiber cable array. Each fiber in the fiber ribbon can carry one channel of optical data in excess of 10 Gbps between a pair of vertical cavity surface emitting laser (VCSEL) and a photo detector. Such data rate is making new records owing to laser and photo-detector speed improvements. To date, 12 channel fiber ribbons have been used to send 120 Gbps data between a pair of optical transceivers. Array fiber connectors that allow the interconnect of two of more of these ribbon fiber based cables have been demonstrated to handle up to 6 rows of 12 fiber ribbons for an aggregate cross section bandwidth of at least 12×6×10 Gbps or 720 Gbps.

Since the introduction of MPO (Multi-fiber Push On) array fiber connector in 1993, there have been constant innovations and improvements of the most popular array fiber connector family. FIG. 1 replicates FIG. 1 of U.S. Pat. No. 7,006,738 and discloses a multi-row fiber connector ferrule that allows two guide pins to help position 2D fiber arrays from each opposite side of the connector and be installed from the side walls. FIG. 2 replicates FIG. 1 of U.S. Pat. No. 6,848,870 and suggests that fibers in an array might be loaded into the bottom half grooves first in a split ferrule MPO connector, which is supposed to ease the fiber insertion difficulty.

The split ferrule approach, however, could not provide the necessary sub-micron position accuracy of fibers. As a result, such type of connectors could not compete with hole-based ferrules for interconnect insertion loss. Therefore, the industry has overwhelmingly adopted the hole-array-based MPO ferrules for low insertion loss oriented array fiber connectors. To help its expansion of fiber capacity from 1 single row of 12 fibers to multiple rows, in another prior art, a staircase structure has been introduced. FIG. 3 shows an example of traditional MPO connector 300 having a staircase structure, where three or four steps of the staircase may be visible via an opening on one side of the connector. From the opening, there is a short section of the fiber groove staircase that can help fibers already laid onto the grooves to be pushed into the high position ferrule hole array. Before reaching a fiber hole, an open groove as part of the hole extension is provided so that an MPO connector assembly man can first lay fibers into these staircase fiber grooves and then pushes the fibers into the hole array. The process to use this ferrule is for the assembly man to first lay the bottom most 12 fibers through the left-hand side window, as shown in FIG. 3, onto the bottom-staircase and then pushes them into the corresponding bottom-most hole array. This process repeats for the staircase immediately above the bottom-most one until all six rows of fibers are inserted into their right positions.

As the bandwidth-driven fiber count grows in a fiber array connector such as MPO, fiber insertion process becomes troublesome in assembly line. Even if a fiber groove staircase structure is used to help guide fibers, assembly workers often complain that sometimes only 1 or 2 fibers missing the guide slightly and stuck somewhere would hinder the entire row of 12 fibers in a ribbon to get through. The situation gets worse as the number of fiber ribbon rows increases. There are reports that sometime one assembly worker cannot even get one 6-row MPO ferrule done in a full day.

One embodiment of the current invention discloses an open-lid structure that is based on single or multi-row fiber array connector ferrules and modified in such a way that it makes a lot easier to insert fibers. The open-lid structure can help both manual and future machine based automations.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to an open-lid fiber connector. According to one aspect of the present invention, the open-lid fiber connector allows a human operator or a machine automation to closely monitor how an array of fibers is placed on a step of a staircase and each of the fibers is inserted via a groove into a corresponding hole or hollow channel.

According to one embodiment, a conventional fiber connector is modified by cutting open at least a portion of one side of the conventional fiber connector to fully expose the internal structure including a staircase, where each step of the staircase includes an array of grooves. Arrays of fibers are sequentially placed onto corresponding steps on the staircase, where each of the fibers is inserted into a corresponding hollow channel. The opening that was cut out is then sealed with a cover. A type of adhesive may be applied through a window originally on the side of the conventional fiber connector.

Depending on the implementation, the portion that is to be cut from one side of the conventional fiber connector varies. In one embodiment, the cut is made near the edge of the connector to fully expose the internal structure of the connector and make it easy to lay out arrays of fibers onto the corresponding steps of the staircase in the structure. In another embodiment, the cut is made by removing some or all of a layer of the connector to fully expose the internal structure of the connector.

The present invention may be implemented as an apparatus or a method for making a fiber connector. Different implementations may yield different objects, features, and advantages.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 replicates FIG. 1 of U.S. Pat. No. 7,006,738;

FIG. 2 replicates FIG. 1 of U.S. Pat. No. 6,848,870;

FIG. 3 shows an example of a staircase structure in a conventional connector, where three or four rows are visible via an opening on one side of the connector;

FIG. 4 illustrates how to convert a conventional MPO fiber connector ferrule into a new open-lid structured counterpart according to one embodiment of the present invention;

FIG. 5 shows an example of how the open-lid MPO fiber connector is used for fiber insertion process;

FIG. 6 shows a (plastic) boot is applied to secure the fibers once rows or arrays of fibers are firmly inserted into their corresponding hollow channels;

FIG. 7 shows quick dry epoxy or glue may be used to temporarily hold up the fibers and then use thermally cured epoxy to fill the entire cavity space;

FIG. 8 shows a completed fiber array connector that retrofits any sockets that are designed to accommodate a conventional MPO fiber connector;

FIG. 9 shows an example of internal structure having six steps in a staircase to accommodate six ribbons, rows or arrays of fibers;

FIG. 10 shows another embodiment in which a conventional MPO fiber connector is cut open by removing a top layer of the connector to expose the internal structure therein; and

FIG. 11 shows a similar embodiment in which a conventional MPO fiber connector is cut half open by removing a part of a top layer of the connector to expose the internal structure therein.

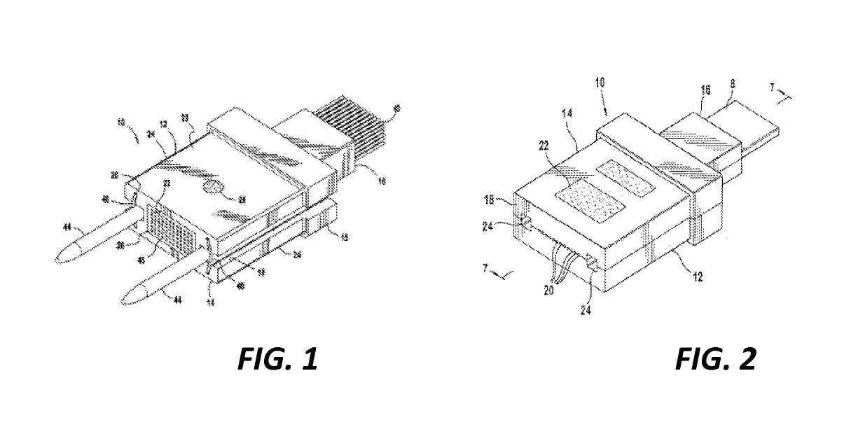

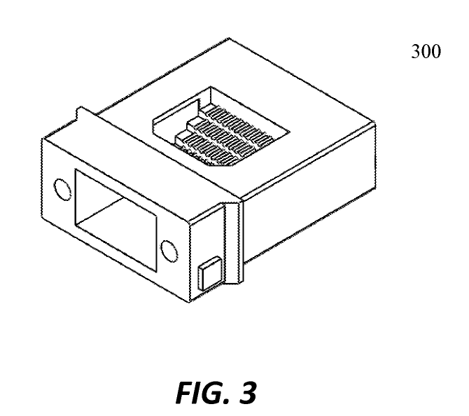

### DESCRIPTION OF THE PREFERRED EMBODIMENTS

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

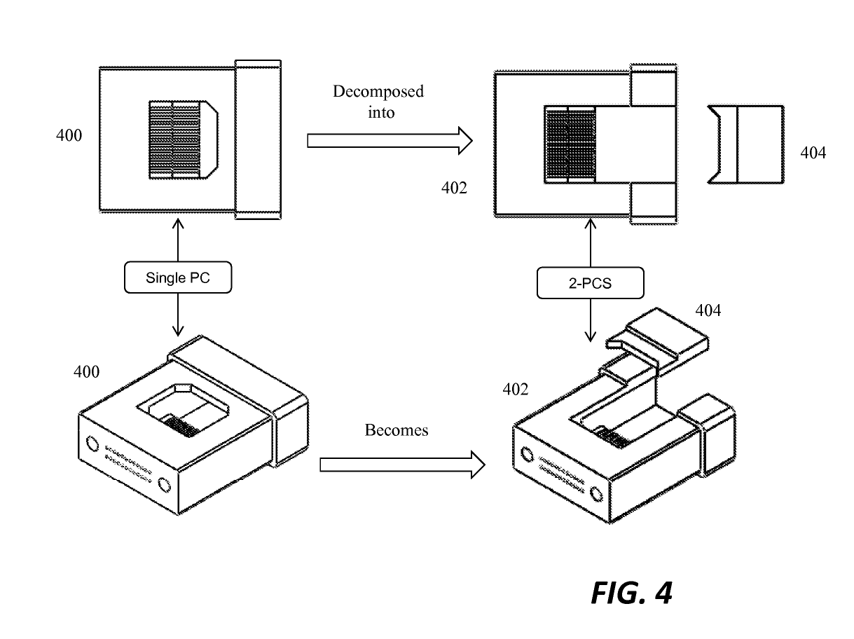

Embodiments of the present invention are discussed herein with reference to FIGS. 4-11. However, those skilled in the art will readily appreciate that the detailed description given herein with respect to these figures is for explanatory purposes as the invention extends beyond these limited embodiments.

Referring now to the drawings, in which like numerals refer to like parts throughout the several views, FIG. 4 illustrates how to convert a conventional MPO fiber connector ferrule 400 into a new open-lid structured counterpart 402. An example of the convention MPO fiber connector ferrule 400 may be provided by US Conec Ltd. located at 1138 25th Street Southeast Hickory, N.C. 28602.

To facilitate the understanding of the convention, FIG. 4 shows a 2D view and a 3D view of the convention MPO fiber connector ferrule 400 on the left and a corresponding 2D view and 3D view of the new open-lid structured counterpart 402, herein referred to as an open-lid MPO fiber connector. According to one embodiment, the convention MPO fiber connector ferrule 400 is cut open to expose the internal structure (e.g., the staircase and grooves), where the cut-out portion is referred to as an opening that can be covered with a cover 404 to facilitate the seal of the internal structure after the fiber arrays are laid out properly.

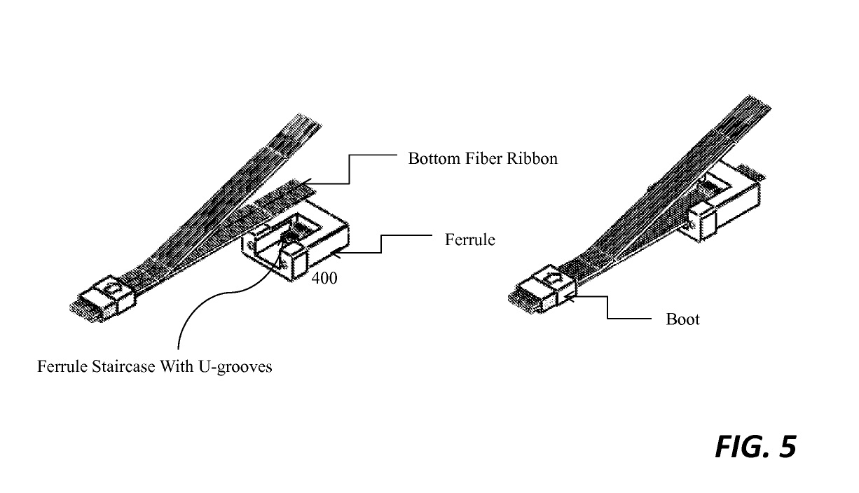

FIG. 5 shows an example of how the open-lid MPO fiber connector 402 is used for fiber insertion process. One of the key benefits, advantages and objectives in the present invention is to facilitate the fiber insertion process in assembly. It can be seen, with the open-lid, each row of fibers can be loaded from the top to a corresponding staircase fiber groove before an assembly operator examines and confirms that these fibers are firmly positioned onto the grooves and can be pushed into the holes of the ferrule.

In the prior art, these fibers must be inserted from an opening on the left of FIG. 4. It can be well understood that the insertion process cannot easily be visually monitored. The top loading as shown in FIG. 5 can separate the fiber ribbons from row to row and have a bigger opening and better visual angles to monitor the insertion process. Loading an array of fibers or a fiber ribbon and the fiber insertion can be done in sequence from the bottom row to the top row in the connector.

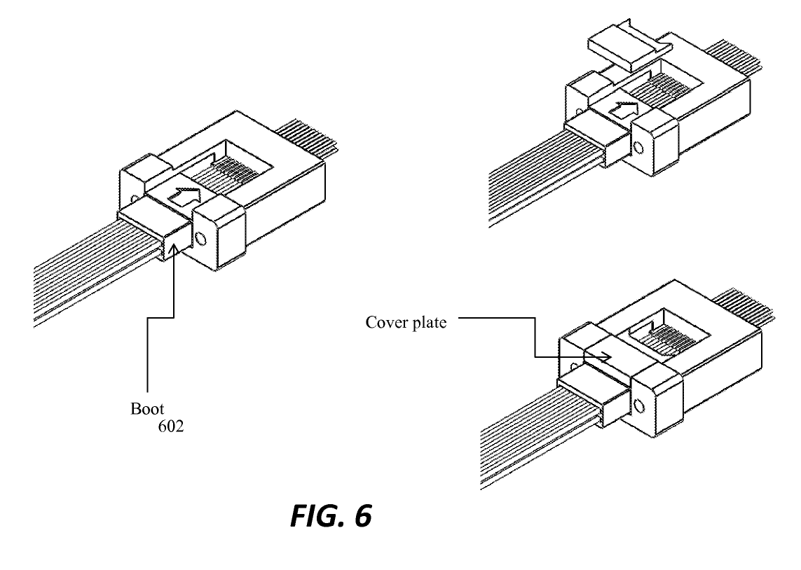

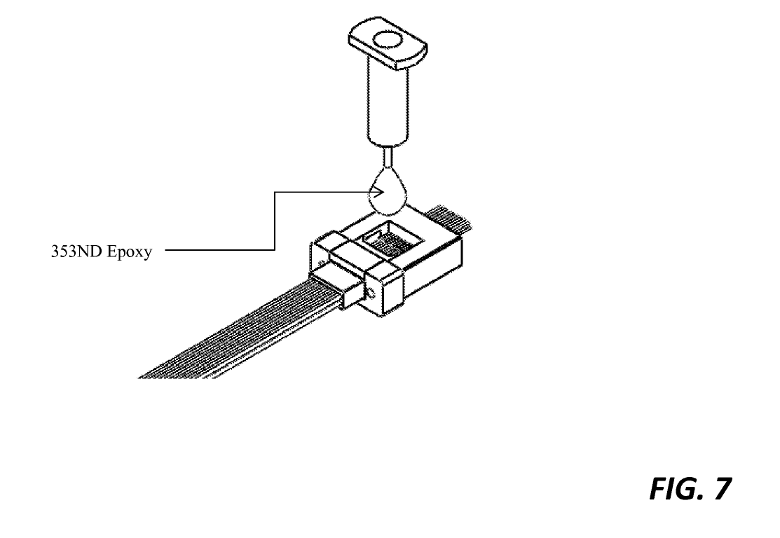

Once rows of fibers are firmly inserted into their corresponding holes, a (plastic) boot 602 is applied to secure the fibers as shown in FIG. 6. The lid 404 can then be applied back to the cur-out opening and is sealed with a type of adhesive (e.g., epoxy). In order not to delay the entire process, this step can use quick dry epoxy or glue for the temporary fixes and then use thermally cured epoxy to fill the entire cavity space as shown in FIG. 7.

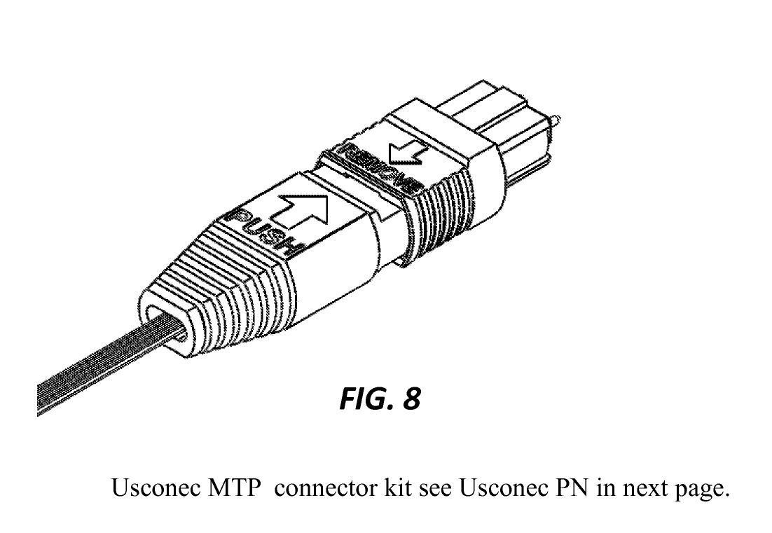

Finally, an assembly worker can complete other steps of making this ferrule into a complete array fiber connector after polishing the fibers along with the fully epoxy cured ferrule, installing the connector housing, etc. FIG. 8 shows a completed fiber array connector that retrofits any sockets that are designed to accommodate a conventional MPO fiber connector.

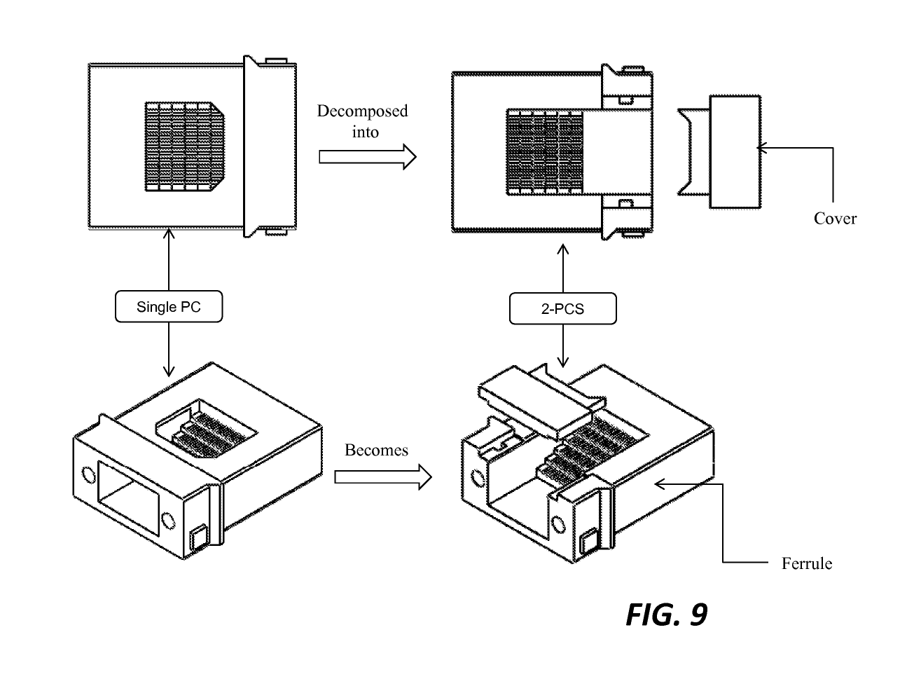

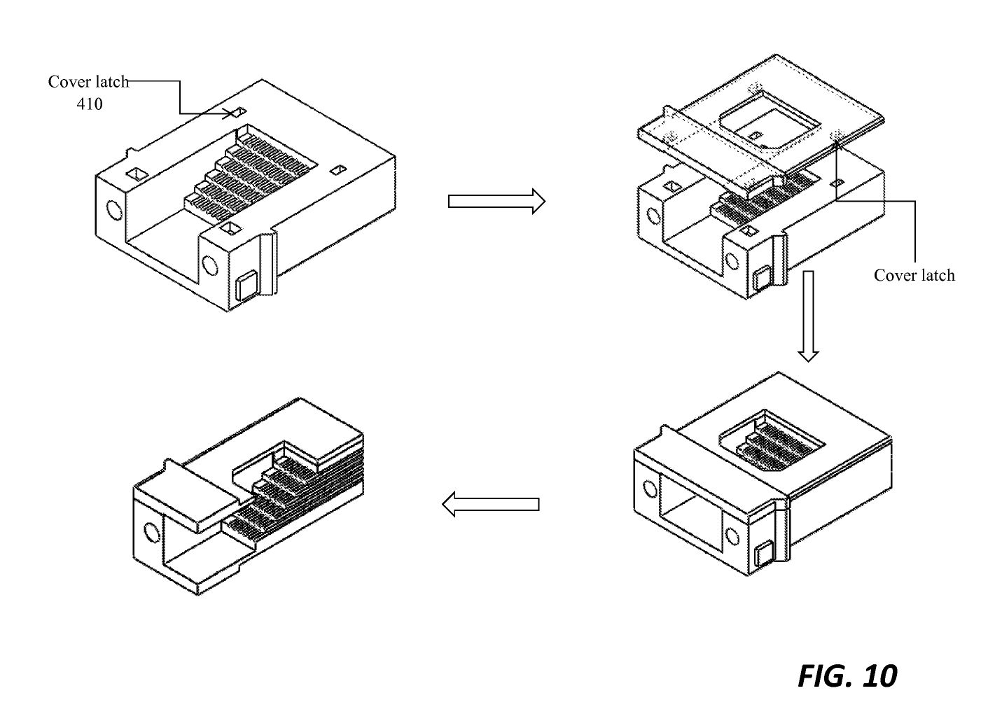

In a similar way, a 2-piece open-lid ferrule can be made for ferrules of more than two rows of holes. FIG. 9 shows an example of internal structure having six steps in a staircase to accommodate six ribbons, rows or arrays of fibers. FIG. 10 shows another embodiment in which a conventional MPO fiber connector is cut open by removing a top layer of the connector to expose the internal structure therein. After ribbons of fibers are stacked according to the staircase and fibers are inserted into corresponding holes or hollow channels, a cover is placed upon the modified connector to recover the cutout. Depending on implementation, the cover may be made separately or from the removed portion. In one embodiment, the cover may be placed onto the cutout by latches 410. In one embodiment, the cover is not to completely seal the internal structure and leaves an opening to allow an operator to fill in with a type of epoxy to permanently seal the fibers as well as the opening.

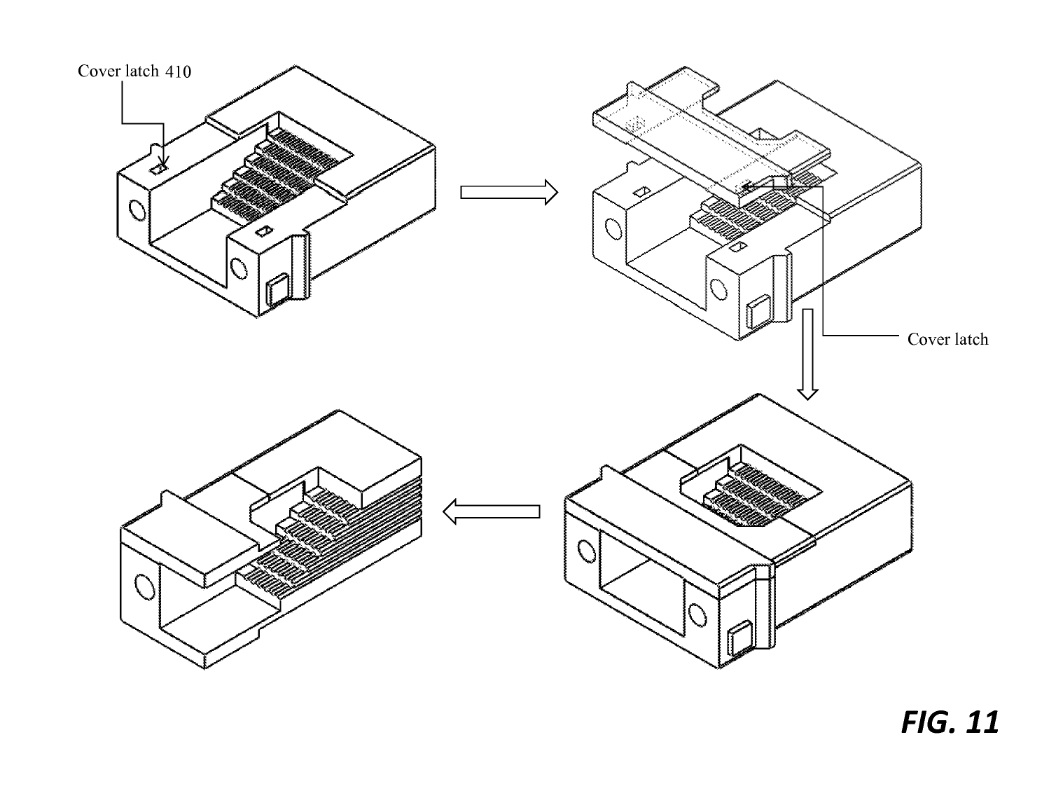

FIG. 11 shows a similar embodiment in which a conventional MPO fiber connector is cut half open by removing part of a top layer of the connector to expose the internal structure therein. After ribbons of fibers are stacked according to the staircase and fibers are inserted into corresponding holes or hollow channels, a cover is placed upon the modified connector to cover the exposed internal structure. Depending on implementation, the cover may be made separately or from the removed portion. In one embodiment, the cover is not to completely seal the internal structure and leaves an opening to allow an operator to fill in with a type of epoxy to permanently seal the fibers as well as the opening.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, the open-lid MPO fiber connector as disclosed herein may be made from scratch according the structure as described above. Accordingly, the scope of the present invention is defined by the appended claims rather than the foregoing description of embodiments.

What we claim is:

1. A method for making an open-lid fiber connector, the method comprising:
providing a conventional connector;
cutting open at least a portion of one side of the conventional connector to expose fully an internal structure including a staircase;
placing arrays of fibers sequentially onto corresponding steps on the staircase, wherein each of the fibers is inserted into a corresponding hollow channel; and
covering the portion with a cover.

2. The method as recited in claim 1, further comprising filling in with a type of adhesive to permanently position the fibers in the connector.

3. The method as recited in claim 2, wherein the cover leaves an opening on the side of the conventional connector.

4. The method as recited in claim 3, wherein the adhesive is applied through the opening.

5. The method as recited in claim 4, wherein the adhesive is epoxy and thermally cured.

6. The method as recited in claim 3, further comprising applying a boot to secure the arrays of fibers to the connector.

7. The method as recited in claim 1, wherein the portion of one side of the conventional connector is in the middle of the one side.

8. The method as recited in claim 1, wherein the portion of one side of the conventional connector is an entire layer of the one side.

9. The method as recited in claim 1, wherein the portion of one side of the conventional connector is a layer portion across the one side.

10. The method as recited in claim 1, wherein the open-lid fiber connector retrofits to any sockets that are designed to accommodate the conventional connector.

11. The method as recited in claim 1, wherein said placing arrays of fibers sequentially onto corresponding steps on the staircase is performed by a human operator who visually inspects how one array of fibers is placed on a corresponding step after another array of fibers.

12. The method as recited in claim 11, wherein the human operator sees how each of the fibers is inserted into a corresponding hollow channel.
